(19) United States
(12) Patent Application Publication
(10) Pub. No.: US 2026/0258321 A1
(43) Pub. Date: Sep. 3, 2026

(54) AQUEOUS HARD SURFACE CLEANING FORMULATION

(71) Applicants: Rohm and Haas Company, Collegeville, PA (US); Dow Global Technologies LLC, Midland, MI (US)

(72) Inventors: Daniel S. Miller, Phoenixville, PA (US); Afua Sarpong Karikari, Bristol, PA (US); Ashish Jayaraman, Conchohocken, PA (US); Scott Backer, Phoenixville, PA (US)

(21) Appl. No.: 18/882,831

(22) PCT Filed: Mar. 15, 2023
(86) PCT No.: PCT/US2023/015239

§ 371 Date: Sep. 12, 2024

Related U.S. Application Data
(60) Provisional application No. 63/320,724, filed on Mar. 17, 2022.

(51) Int. Cl. C11D 1/72; C11D 3/20; C11D 3/30; C11D 3/33; C11D 3/37; C11D 3/382; C11D 3/43; C11D 3/48

(52) U.S. Cl. CPC C11D 1/72; C11D 3/2068; C11D 3/2086; C11D 3/30; C11D 3/33; C11D 3/3707; C11D 3/382; C11D 3/43; C11D 3/48; C11D 2111/14

(57) ABSTRACT

An aqueous hard surface cleaning formulation is provided including water; 0.1 to <5 wt %, based on weight of the aqueous hard surface cleaning formulation, of a nonionic branched alcohol alkoxylate surfactant having a hydrophobic-lipophilic balance, HLB, of 0.5 to 11.5; and 0.01 wt % to 25 wt %, based on weight of the aqueous hard surface cleaning formulation, of an ethoxylated phenol having formula (I), wherein T is an average of >2.5 to 14; wherein the weight of ethoxylated phenol divided by the weight of nonionic branched alcohol alkoxylate surfactant contained in the aqueous hard surface cleaning formulation is 0.1 to <5.

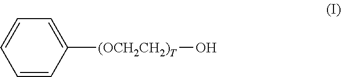

The present invention relates to an aqueous hard surface cleaning formulation. In particular, the present invention relates to an aqueous hard surface cleaning formulation including (a) water; (b) 0.1 to <5 wt %, based on weight of the aqueous hard surface cleaning formulation, of a nonionic branched alcohol alkoxylate surfactant having a hydrophobic-lipophilic balance, HLB, of 0.5 to 11.5; and (c) 0.01 wt % to 25 wt %, based on weight of the aqueous hard surface cleaning formulation, of an ethoxylated phenol having formula (I)

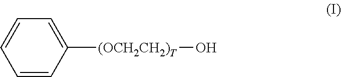

wherein T is an average of >2.5 to 14; wherein the weight of ethoxylated phenol (c) divided by the weight of nonionic surfactant (b) contained in the aqueous hard surface cleaning formulation is 0.1 to <5.

Aqueous hard surface cleaning compositions have a wide array of uses. For example, use cleaning hard surfaces such as floors, counters, walls, tables, and other things made of, for example, wood, stone, laminate, ceramic and plastic materials which need to be cleaned periodically of accumulated dirt, oil, grease, and other contaminants.

Low hydrophilic-lipophilic balance (HLB) nonionic surfactants have been recognized as useful ingredients for aqueous hard surface cleaning compositions given that they facilitate the removal of greasy soils from hard surfaces. Such low HLB nonionic surfactants, however, tend to be insoluble in water rich formulations. Hence, incorporation of low HLB surfactants into aqueous hard surface cleaning compositions can lead to concerns with formulation instability manifested by phase separation in the composition container resulting in undesirable product appearance and inconsistent surfactant delivery to hard surfaces for cleaning.

A conventional approach to facilitate incorporation of low HLB nonionic surfactants into aqueous hard surface cleaning compositions is to blend a high HLB surfactant or ionic surfactant (e.g., an anionic surfactant) with the low HLB nonionic surfactant to facilitate solubilization of the low HLB nonionic surfactant in formulation.

Notwithstanding, there remains a continuing need for effective aqueous hard surface cleaning formulations that do not require incorporation of a high HLB surfactant or ionic surfactant to stabilize the formulation from phase separation.

The present invention provides an aqueous hard surface cleaning formulation, comprising: (a) water; (b) 0.1 to <5 wt %, based on weight of the aqueous hard surface cleaning formulation, of a nonionic branched alcohol alkoxylate surfactant having a hydrophobic-lipophilic balance, HLB, of 0.5 to 11.5; and (c) 0.01 wt % to 25 wt %, based on weight of the aqueous hard surface cleaning formulation, of an ethoxylated phenol having formula (I)

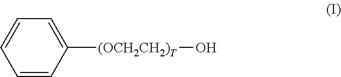

wherein T is an average of >2.5 to 14; wherein the weight of ethoxylated phenol (c) divided by the weight of nonionic surfactant (b) contained in the aqueous hard surface cleaning formulation is 0.1 to <5; wherein the aqueous hard surface cleaning formulation contains less than 0.003 wt %, based on weight of the aqueous hard surface cleaning formulation, of a quaternary ammonium salt having at least one C₈₋₁₈ alkyl group; wherein the aqueous hard surface cleaning formulation contains less than 0.05 wt %, based on weight of the aqueous hard surface cleaning formulation, of cationic biocide; wherein cationic biocide is selected from the group consisting of quaternary ammonium salts (“quats”) and biguanide compounds; wherein the aqueous hard surface cleaning formulation contains <0.01 wt %, based on weight of the aqueous hard surface cleaning formulation, of castor oil derivative; wherein the aqueous hard surface cleaning formulation contains <0.5 wt % or >3 wt %, based on weight of the aqueous hard surface cleaning formulation, of a mixture of (i) amino carboxylic acid chelator and (ii) polycarboxylic acid chelator; wherein the amino carboxylic acid chelator is a chelating agent having a nitrogen atom and a carboxy group; and wherein the polycarboxylic acid chelator is a chelating agent having at least two functional groups per molecule including at least one carboxy group, wherein the functional groups are selected from carboxy groups and a hydroxy groups; and wherein the aqueous hard surface cleaning formulation contains less than 0.5 wt %, based on weight of the aqueous hard surface cleaning formulation, of an ingredient of formula (VI)

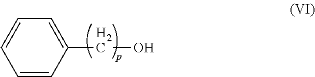

wherein p is 1 or 2.

The present invention provides a method of cleaning a hard surface, comprising: selecting a aqueous hard surface cleaning formulation of the present invention; applying the aqueous hard surface cleaning formulation to a soiled hard surface having a material to be removed; and rubbing the aqueous hard surface cleaning formulation on the soiled hard surface to provide a cleaned hard surface, wherein at least some of the material to be removed has been removed.

### DETAILED DESCRIPTION

Applicants have surprisingly found that an aqueous hard surface cleaning formulation containing a unique combination of (b) a nonionic branched alcohol alkoxylate surfactant having a hydrophobic-lipophilic balance, HLB, of 0.5 to 11.5 and (c) an ethoxylated phenol having formula (I)

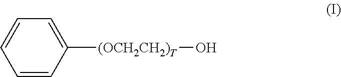

wherein T is an average of >2.5 to 14; in a weight ratio of (c) divided by (b) of 0.1 to <5; result in a phase stable formulation after being stored for 20 days at 21° C., while exhibiting a cloud point temperature of 25 to <40° C. and exceptional cleaning performance on greasy soils.

Unless otherwise indicated, ratios, percentages, parts, and the like are by weight. Weight percentages (or wt %) in the composition are percentages of dry weight, i.e., excluding any water that may be present in the composition. Percentages of monomer units in the polymer are percentages of solids weight, i.e., excluding any water present in a polymer emulsion.

As used herein, unless otherwise indicated, the terms “weight average molecular weight” and “Mw” are used interchangeably to refer to the weight average molecular weight as measured in a conventional manner with gel permeation chromatography (GPC) and conventional standards, such as polyethylene glycol standards. GPC techniques are discussed in detail in Modem Size Exclusion Chromatography, W. W. Yau, J. J. Kirkland, D. D. Bly; Wiley-Interscience, 1979, and in A Guide to Materials Characterization and Chemical Analysis, J. P. Sibilia; VCH, 1988, p. 81-84. Weight average molecular weights are reported herein in units of Daltons.

The term “hard surface” as used herein and in the appended claims means any porous or nonporous inanimate surfaces. Preferred hard surfaces are selected from the group consisting of ceramic (e.g., toilet bowls, sinks, showers, kitchen and bathroom tile), glass (e.g., windows), metal (e.g., drain pipe, faucets, fixtures), polymer (e.g., PVC piping, fiberglass, Corian®), stone (e.g., granite, marble) and combinations thereof; wherein the hard surface is not a silicon wafer or a semiconductor substrate.

The term “hydrophilic-lipophilic balance” or “HLB” used herein and in the appended claims refers to the HLB value calculated by the effective chain length (ECL) method using Equations (eq. 1)-(eq. 3)¹

$$HLB = 7 + ( {GN}_{CH 2 / CH 3} \cdot {N}_{CH 2 / CH 3} ) + ( G {N}_{EO} \cdot {N}_{E O , eff} ) + ( {GN}_{PO} \cdot {N}_{P O , eff} ) + \sum ( other hydrophilic groups ) + \sum ( other lipophilic groups ) \qquad ( eq . 1 )$$

$${N}_{E O , eff} = 13.45 \cdot ln ( {N}_{EO} ) - 0.16 \cdot {N}_{EO} + 1.26 \qquad ( eq . 2 )$$

$${N}_{P O , eff} = 2 \text{.057} \cdot {N}_{P O} + 9.06 \qquad ( eq . 3 )$$

wherein HLB is the hydrophilic-lipophilic balance for the surfactant molecule; wherein GN_{CH2/CH3} is the group number for (—CH₂—) and (—CH₃) groups in the lipophilic portion of the surfactant molecule; wherein N_{CH2/CH3} is the number of (—CH₂—) and (—CH₃) groups in the lipophilic portion of the surfactant molecule; wherein GN_{EO} is the group number for —CH₂CH₂O— groups (“EO groups”); wherein N_{EO,eff} is the effective number of EO groups in the surfactant molecule calculated using equation (eq. 2); wherein N_{EO} is the actual number of EO groups in the surfactant molecule; wherein GN_{PO} is the group number determined by ECL method for —CH₂CH₂CH₂O— groups, —CH(CH₃)CH₂O— groups
and —CH₂CH(CH₃)O— groups (collectively “PO groups”); wherein N_{PO,eff} is the effective number of PO groups in the surfactant molecule calculated using Equation (eq. 3); wherein N_{PO} is the actual number of PO groups in the surfactant molecule; other hydrophilic groups refers to hydrophilic groups other than EO groups present in the surfactant molecule, if any; and other lipophilic groups refers to lipophilic groups other than —CH₂— groups and —CH₃ groups present in the lipophilic portion of the surfactant molecule, and PO groups present in the surfactant molecule, if any. Group numbers for hydrophilic groups and lipophilic groups are provided in TABLE 1. ¹ X. Guo et al., Calculation of hydrophile-lipophile balance for polyethoxylated surfactants by group contribution method, Journal of Colloid and Interface Science 298 (2006) 441-450.

TABLE 1

| Hydrophilic | | Lipophilic | |
|---|---|---|---|
| | (ECL) | | (ECL) |
| | Group | | Group |
| Group | Number | Group | Number |
| —SO₄Na | 38.4 | —CH— | −0.475 |
| —COOK | 20.8 | —CH₂— | −0.475 |
| —COONa | 18.8 | —CH₃ | −0.475 |
| —SO₃Na | 10.7 | ═CH— | −0.475 |
| —N(tertiary amine) | 2.4 | —CF₂— | — |
| Ester (free) | 2.316 | —CF₃ | — |
| —COOH | 1.852 | Phenyl | −1.601 |
| —OH (free) | 2.255 | —CH₂CH₂CH₂O— | −0.15 |
| —CH₂OH | 0.724 | —CH₂(CH₃)CH₂O— | −0.15 |
| —CH₂CH₂OH | 0.479 | —CH₂CH(CH₃)O— | −0.15 |
| —CH₂CH₂CH₂OH | 0.382 | Sorbitan ring | −20.565 |
| —O— | — | | |
| —CH₂CH₂O— | 0.33 | | |
| —CH₂CH₂OOC— | 3.557 | | |
| —OH (sorbitan ring) | 5.148 | | |
| Ester (sorbitan ring) | 11.062 | | |

Preferably, the aqueous hard surface cleaning formulation of the present invention is selected from the group consisting of an aqueous multisurface cleanser, a floor cleanser, a kitchen cleanser, a bathroom cleanser. More preferably, the aqueous hard surface cleaning formulation of the present invention is selected from the group consisting of a floor cleanser and a kitchen cleanser.

Preferably, the aqueous hard surface cleaning formulation of the present invention, comprises: (a) water (preferably, 10 to 99.99 wt % (more preferably, 25 to 98 wt %; most preferably, 50 to 97 wt %), based on the weight of the aqueous cleaning formulation, of the water); (b) 0.1 to <5 wt % (preferably, 0.25 to 4 wt %; more preferably, 0.5 to 3.5 wt %; most preferably, 0.75 to 3 wt %), based on weight of the aqueous hard surface cleaning formulation, of a nonionic branched alcohol alkoxylate surfactant having a hydrophobic-lipophilic balance, HLB, of 0.5 to 11.5 (preferably, 3 to 11; more preferably, 6 to <11; most preferably, 7 to 10.75); and (c) 0.01 wt % to 25 wt % (preferably, 0.1 to 20 wt %; more preferably, 0.5 to 15 wt %; most preferably, 1 to 10 wt %), based on weight of the aqueous hard surface cleaning formulation, of an ethoxylated phenol having formula (I)

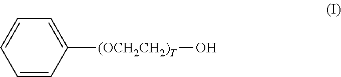

wherein T is an average of >2.5 to 14 (preferably, 3 to 10; more preferably, 3.25 to 8; still more preferably, 3.5 to 7; most preferably, 3.75 to 6.5); wherein the aqueous hard surface cleaning formulation has a weight ratio (c)/(b) equal to the weight of the ethoxylated phenol (c) contained in the aqueous hard surface cleaning formulation divided by the weight of the nonionic surfactant (b) contained in the aqueous hard surface cleaning formulation of 0.1 to <5; wherein the weight of ethoxylated phenol (c) divided by the weight of nonionic surfactant (b) contained in the aqueous hard surface cleaning formulation is 0.1 to <5 (preferably, 0.1 to 4.75; more preferably, 1 to 4.5; most preferably, 1.5 to 4.25); wherein the aqueous hard surface cleaning formulation contains less than 0.003 wt % (preferably, <0.001 wt %; more preferably, <0.0001 wt %; most preferably, less than detectable limit), based on weight of the aqueous hard surface cleaning formulation, of a quaternary ammonium salt having at least one C₈₋₁₈ alkyl group; wherein the aqueous hard surface cleaning formulation contains less than 0.05 wt % (preferably, <0.01 wt %; more preferably, <0.001 wt %; still more preferably, <0.0001 wt %; most preferably, <detectable limit), based on weight of the aqueous hard surface cleaning formulation, of cationic biocide; wherein cationic biocide is selected from the group consisting of quaternary ammonium salts (“quats”) and biguanide compounds; wherein the aqueous hard surface cleaning formulation contains <0.01 wt % (preferably, <0.001 wt %; more preferably, <0.0001 wt %; most preferably, <detectable limit), based on weight of the aqueous hard surface cleaning formulation, of castor oil derivative; wherein the aqueous hard surface cleaning formulation contains <0.5 wt % or >3 wt % (preferably, <0.1 wt % or >5 wt %; more preferably, <0.01 wt %; still more preferably, <0.001 wt %; most preferably, less than detectable limit), based on weight of the aqueous hard surface cleaning formulation, of a mixture of (a) amino carboxylic acid chelator and (b) polycarboxylic acid chelator; wherein the amino carboxylic acid chelator is a chelating agent having a nitrogen atom and a carboxy group; and wherein the polycarboxylic acid chelator is a chelating agent having at least two functional groups per molecule including at least one carboxy group, wherein the functional groups are selected from carboxy groups and a hydroxy groups (e.g., acetic acid, adipic acid, monochloroacetic acid, oxalic acid, succinic acid, oxydisuccinic acid, carboxymethylsuccinic acid, carboxy methyloxy succinic acid, glycolic acid, diglycolic acid, lactic acid, tartaric acid, carboxymethyltartaric acid, citric acid, malic acid, gluconic acid and salts thereof); wherein the aqueous hard surface cleaning formulation contains less than 0.5 wt % (preferably, <0.1 wt %; more preferably, <0.01 wt %; still more preferably, <0.001 wt %; most preferably, less than detectable limit), based on weight of the aqueous hard surface cleaning formulation, of an ingredient of formula (VI)

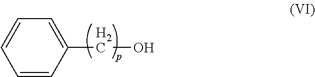

wherein p is 1 or 2 (alternatively, wherein p is 1 to 8).

Preferably, the aqueous hard surface cleaning formulation of the present invention, comprises (a) 10 to 99.99 wt % (preferably, 25 to 98 wt %; more preferably, 50 to 97 wt %), based on the weight of the aqueous hard surface cleaning formulation, of water. Preferable, the aqueous hard surface cleaning formulation of the present invention, comprises (a) 10 to 99.99 wt % (preferably, 25 to 98 wt %; more preferably, 50 to 97 wt %), based on the weight of the aqueous hard surface cleaning formulation, of water, wherein the water is at least one of distilled water, deionized water and industrial soft water.

Preferably, the aqueous hard surface cleaning formulation of the present invention comprises (b) 0.1 to <5 wt % (preferably, 0.25 to 4 wt %; more preferably, 0.5 to 3.5 wt %; most preferably, 0.75 to 3 wt %), based on weight of the aqueous hard surface cleaning formulation, of a nonionic branched alcohol alkoxylate surfactant having a hydrophobic-lipophilic balance, HLB, of 0.5 to 11.5 (preferably, 3 to 11; more preferably, 6 to <11; most preferably, 7 to 10.75). More preferably, the aqueous hard surface cleaning formulation of the present invention comprises (b) 0.1 to <5 wt % (preferably, 0.25 to 4 wt %; more preferably, 0.5 to 3.5 wt %; most preferably, 0.75 to 3 wt %), based on weight of the aqueous hard surface cleaning formulation, of a nonionic branched alcohol alkoxylate surfactant having a hydrophobic-lipophilic balance, HLB, of 0.5 to 11.5 (preferably, 3 to 11; more preferably, 6 to <11; most preferably, 7 to 10.75); wherein the nonionic branched alcohol alkoxylate surfactant is a surfactant having formula (II)

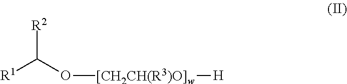

wherein w is an average of 4 to 20 (preferably, 4 to 15; more preferably, 4 to 12; most preferably, 4 to 10); wherein R¹ is selected from the group consisting of a hydrogen and a linear or branched C₁₋₂₀ alkyl group (preferably, a hydrogen and a linear or branched C₁₋₁₅ alkyl group; more preferably, a hydrogen and a linear C₁₋₁₅ alkyl group); wherein R² is selected from the group consisting of a branched C₁₋₂₀ alkyl group and a liner or branched C₁₋₄ hydroxyalkyl group (preferably, branched C₁₋₁₅ alkyl group and a linear or branched C₁₋₄ hydroxyalkyl group; more preferably, C₁₋₁₅ alkyl group and a linear or branched C₁₋₃ hydroxyalkyl group; most preferably, a linear C₁₋₁₅ alkyl group); wherein each R³ is independently selected from the group consisting of a hydrogen, a methyl group and an ethyl group (preferably, wherein all the R³s are hydrogen, or some of the R³s in the surfactant molecule are a hydrogen and some of the R³s in the surfactant molecule are a methyl group); and wherein the sum of the total number of carbon atoms in R¹ and R² collectively is 5 to 21 (preferably, 6 to 20 carbon atoms; more preferably, 7 to 18 carbon atoms; most preferably, 7 to 15 carbon atoms).

Preferably, the aqueous hard surface cleaning formulation of the present invention, comprises (c) 0.01 wt % to 25 wt % (preferably, 0.1 to 20 wt %; more preferably, 0.5 to 15 wt %; most preferably, 1 to 10 wt %), based on weight of the aqueous hard surface cleaning formulation, of an ethoxylated phenol having formula (I)

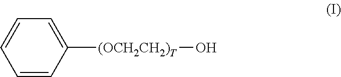

wherein T is an average of >2.5 to 14 (preferably, 3 to 10; more preferably, 3.25 to 8; still more preferably, 3.5 to 7; most preferably, 3.75 to 6.5).

Preferably, the aqueous hard surface cleaning formulation of the present invention has a weight ratio (c)/(b) of ethoxylated phenol (c) to nonionic surfactant (b) equal to the weight of the ethoxylated phenol (c) contained in the aqueous hard surface cleaning formulation divided by the weight of the nonionic surfactant (b) contained in the aqueous hard surface cleaning formulation of 0.1 to <5 (preferably, 0.1 to 4.75; more preferably, 1 to 4.5; most preferably, 1.5 to 4.25).

Preferably, the aqueous hard surface cleaning formulation has a cleaning performance of at least 50% (preferably, at least 60%; more preferably, at least 65%; most preferably, at least 70%). More preferably, the aqueous hard surface cleaning formulation has a cleaning performance of at least 50% (preferably, at least 60%; more preferably, at least 65%; most preferably, at least 70%); wherein the cleaning performance is determined by applying the aqueous hard surface cleaning formulation to a tile (e.g., Premium Excelon Feature Tile & Strip, Chalk II 56830/L597A available from ArmstrongFlooring) soiled with a mixture of 61.04 wt % naptha 60/110, 27.6 wt % Cognis Myritol 318, 8.2 wt % soybean oil and 3.18 wt % carbon black (Mogul L), rubbing the wetted surface using a carpeted scrubber (i.e., 3 mm needle punch carpet purchased from The Felt Store Inc. (West Seneca, NY) adhered to 12.7 g conic weight) for 5 minutes, as described herein in the Examples, to provide a cleaned tile and comparing the grey value of the cleaned tile to that of a virgin tile (100% cleaned) and the stained tile before cleaning (0% cleaned). Most preferably, the aqueous hard surface cleaning formulation has a cleaning performance of at least 50% (preferably, at least 60%; more preferably, at least 65%; most preferably, at least 70%); wherein the cleaning performance is determined as described in the Examples.

Preferably, the aqueous hard surface cleaning formulation of the present invention is phase stable after being stored for 20 days at 21° C. Preferably, the aqueous hard surface cleaning formulation of the present invention is phase stable after being stored for 20 days at 21° C.; wherein the aqueous hard surface cleaning formulation is determined to be phase stable by placing 100 mL of the formulation in a glass container and observing for the presence of a phase split into two or more layers after storage for 20 days at 21° C. The aqueous hard surface cleaning formulation is determined to be phase stable if after said storage period either (i) only one layer is observed in the glass container; or (ii) if a split is observed, there is a major layer including at least 90 wt % (preferably, at least 95 wt %; more preferably, at least 97.5 wt %; most preferably, at least 98 wt %) of the aqueous hard surface cleaning formulation in the glass container.

Preferably, the aqueous hard surface cleaning formulation of the present invention has a cloud point temperature of 25° C. to <40° C. (preferably, 25 to 39.5° C.; more preferably, 25 to 39° C.; most preferably, 27.5 to 35° C.). The term “cloud point” as used herein and in the appended claims refers to a well-known property associated with nonionic surfactant containing aqueous formulations relating to the solubility of nonionic surfactant in an aqueous formulation decreasing with increasing temperature of the formulation. The temperature at which the appearance of a second phase is observable in a given nonionic surfactant containing aqueous formulation is referred to as the “cloud point temperature”.

Preferably, the aqueous hard surface cleaning formulation of the present invention, further comprises 0 to 50 wt %, based on the weight of the aqueous hard surface cleaning formulation, of an additive. Preferably, the aqueous hard surface cleaning formulation of the present invention, further comprises 0 to 50 wt %, based on the weight of the aqueous hard surface cleaning formulation, of an additive selected from the group consisting of a salt, a builder, an enzyme (e.g., protease, amylase, lipase, cellulase), a corrosion inhibitor, a pH adjusting agent (e.g., an acid), a bleaching agent (e.g., sodium percarbonate, sodium perborate), a bleach activator (e.g., tetraacetylethylenediamine (TAED)), a bleach catalyst (e.g., manganese(II) acetate, cobalt(II) chloride, bis(TACN)magnesium trioxide diacetate), an abrasive, a fragrance, an antimicrobial agent (e.g., biocides), a colorant (e.g., dyes); a thickener; foam stabilizer; foam enhancer; chelating agent; a hydrotrope; an organic cosolvent and mixtures thereof.

Preferably, the aqueous hard surface cleaning formulation of the present invention, further comprises a salt. More preferably, the aqueous hard surface cleaning formulation of the present invention, further comprises a salt; wherein the salt is selected from the group consisting of alkali metal halide salts (e.g., sodium chloride, potassium chloride); ammonium salts; nitrates; sulfates; nitrites and mixtures thereof. Most preferably, the aqueous hard surface cleaning formulation of the present invention, further comprises 0 to 20 wt % (preferably, 0.1 to 20 wt %; more preferably, 0.1 to 10 wt %), based on the weight of the aqueous hard surface cleaning formulation, of a salt; wherein the salt is selected from the group consisting of alkali metal halide salts (e.g., sodium chloride, potassium chloride); ammonium salts; nitrates; sulfates; nitrites and mixtures thereof.

Preferably, the aqueous hard surface cleaning formulation of the present invention, further comprises a builder. More preferably, the aqueous hard surface cleaning formulation of the present invention, further comprises 0 to 50 wt % (preferably, 0.1 to 30 wt %; more preferably, 0.1 to 15 wt %), based on the weight of the aqueous hard surface cleaning formulation, of a builder. Most preferably, the aqueous hard surface cleaning formulation of the present invention further comprises a builder; wherein the builder is selected from the group consisting of inorganic builders (e.g., tripolyphosphate, pyrophosphate); alkali metal carbonates; borates; bicarbonates; hydroxides; zeolites; citrates; polycarboxylates; monocarboxylates; aminotrismethylenephosphonic acid; salts of aminotrismethylenephosphonic acid; hydroxyethanediphosphonic acid; salts of hydroxyethanediphosphonic acid; diethylenetriaminepenta(methylenephosphonic acid); salts of diethylenetriaminepenta(methylenephosphonic acid); ethylenediaminetetraethylene-phosphonic acid; salts of ethylenediaminetetraethylene-phosphonic acid; oligomeric phosphonates; polymeric phosphonates; mixtures thereof.

Preferably, the aqueous hard surface cleaning composition of the present invention, comprises a pH adjusting agent. More preferably, the aqueous hard surface cleaning composition of the present invention, comprises a pH adjusting agent; wherein the pH adjusting agent is selected from the group consisting of an inorganic acid, an inorganic base, an organic acid, an organic base and mixtures thereof. Most preferably, the aqueous hard surface cleaning composition of the present invention, comprises a pH adjusting agent; wherein the pH adjusting agent is selected from the group consisting of at least one of sodium hydroxide, potassium hydroxide, sodium carbonate, potassium carbonate, monoethanolamine, triethanolamine, aminomethylpropanol, aminomethylpropanediol, trimethamine, gluconic acid, lactic acid, citric acid, glycolic acid, acetic acid, propionic acid, succinic acid, glutaric acid, adipinic acid, butanedioic acid, isoascorbic acid, ascorbatic acid, tatric acid, and mixtures thereof.

Preferably, the aqueous hard surface cleaning formulation of the present invention, further comprises a bleaching agent. More preferably, the aqueous hard surface cleaning formulation of the present invention comprises a bleaching agent 0 to 10 wt % (preferably, 1 to 5 wt %; more preferably, 2 to 4 wt %), based on the weight of the aqueous hard surface cleaning formulation, of a bleaching agent. Most preferably, the aqueous hard surface cleaning formulation of the present invention, further comprises 0 to 10 wt % (preferably, 1 to 5 wt %; more preferably, 2 to 4 wt %), based on the weight of the aqueous hard surface cleaning formulation, of a bleaching agent; wherein the bleaching agent is selected from the group consisting of peracids, perborates, percarbonates, chlorine-generating substances (e.g., sodium hypochlorite, chloroisocyanurate), hydrogen peroxide, sources of hydrogen peroxide and mixtures thereof.

Preferably, the aqueous hard surface cleaning formulation of the present invention, further comprises a chelating agent. More preferably, the aqueous hard surface cleaning formulation of the present invention further comprises: 0 to 20 wt % (preferably, 0.1 to 20 wt %; more preferably, 0.5 to 10 wt %; most preferably, 1 to 5 wt %), based on the weight of the aqueous hard surface cleaning formulation, of a chelating agent. Most preferably, the aqueous hard surface cleaning formulation of the present invention further comprises 0 to 20 wt % (preferably, 0.1 to 20 wt %; more preferably, 0.5 to 10 wt %; most preferably, 1 to 5 wt %), based on the weight of the aqueous hard surface cleaning formulation, of a chelating agent, wherein the chelating agent is selected from the group consisting of ethylenediamine tetraacetic acid; ethylenediamine triacetic acid; ethylenediamine tetrapropionic acid; diethylenetriamine pentaacetic acid; nitrilotriacetic acid; oxydisuccinic acid; iminodisuccinic acid; benzene hexacarboxylic acid; poly(meth)acrylic acid, polyacrylic acid/polymethacrylic acid copolymers; benzene polycarboxylic acids; gluconic acid; sulfamic acid; oxalic acid; phosphoric acid; phosphonic acid; organic phosphonic acids; acetic acid; citric acid; methylglycinediacetic acid (MGDA); glutamic acid-N,N-diacetic acid (GLDA); iminodisuccinic acid (IDSA); 1,2-ethylenediamine disuccinic acid (EDDS); aspartic acid diacetic acid (ASDA); sodium, potassium, lithium, ammonium and substituted ammonium salts thereof; salts thereof and mixtures thereof.

Preferably, the aqueous hard surface cleaning formulation of the present invention, further comprises a hydrotrope. More preferably, the aqueous hard surface cleaning formulation of the present invention further comprises: 0 to 10 wt % (preferably, 0.1 to 10 wt %; more preferably, 0.5 to 7.5 wt %; most preferably, 1 to 5 wt %), based on the weight of the aqueous hard surface cleaning formulation, of a hydrotrope. Still more preferably, the aqueous hard surface cleaning formulation of the present invention, further comprises: 0 to 10 wt % (preferably, 0.1 to 10 wt %; more preferably, 0.5 to 7.5 wt %; most preferably, 1 to 5 wt %), based on the weight of the aqueous hard surface cleaning formulation, of a hydrotrope; wherein the hydrotrope is selected from the group consisting of urea; monoethanolamine; diethanolamine; triethanolamine; and calcium, sodium, potassium, ammonium and alkanol ammonium salts of xylene sulfonic acid, toluene sulfonic acid, ethylbenzene sulfonic acid and cumene sulfonic acid; and mixtures thereof. Yet more preferably, the aqueous hard surface cleaning formulation of the present invention, further comprises: 0 to 10 wt % (preferably, 0.1 to 10 wt %; more preferably, 0.5 to 7.5 wt %; most preferably, 1 to 5 wt %), based on the weight of the aqueous hard surface cleaning formulation, of a hydrotrope; wherein the hydrotrope is selected from the group consisting of sodium toluene sulfonate, potassium toluene sulfonate, sodium xylene sulfonate, ammonium xylene sulfonate, potassium xylene sulfonate, calcium xylene sulfonate, sodium cumene sulfonate, ammonium cumene sulfonate and mixtures thereof. Most preferably, the aqueous cleaning formulation of the present invention, further comprises: 0 to 10 wt % (preferably, 0.1 to 10 wt %; more preferably, 0.5 to 7.5 wt %; most preferably, 1 to 5 wt %), based on the weight of the aqueous cleaning formulation, of a hydrotrope; wherein the hydrotrope includes sodium xylene sulfonate (preferably, is sodium xylene sulfonate).

Preferably, the aqueous hard surface cleaning formulation of the present invention, further comprises an organic cosolvent. More preferably, the aqueous hard surface cleaning formulation of the present invention further comprises: 0 to 10 wt % (preferably, 0.01 to 10 wt %; more preferably, 1 to 8 wt %; most preferably, 2.5 to 7.5 wt %), based on the weight of the aqueous hard surface cleaning formulation, of an organic cosolvent. Preferably, the organic cosolvent is miscible with water. More preferably, the organic cosolvent is selected from the group consisting of an aliphatic alcohol (e.g., C₁₋₆ alkanols, C₁₋₆ alkyl diols); a monoalkylene glycol ether (e.g., ethylene glycol propyl ether, ethylene glycol n-butyl ether, ethylene glycol t-butyl ether, propylene glycol propyl ether, propylene glycol n-butyl ether, propylene glycol t-butyl ether, propylene glycol methyl ether acetate, propylene glycol diacetate); a polyalkylene glycol ether (e.g., diethylene glycol ethyl ether, diethylene glycol propyl ether, diethylene glycol n-butyl ether, diethylene glycol t-butyl ether, diethylene glycol hexyl ether, dipropylene glycol methyl ether, dipropylene glycol ethyl ether, dipropylene glycol propyl ether, dipropylene glycol n-butyl ether, dipropylene glycol t-butyl ether, dipropylene glycol phenyl ether, dipropylene glycol methyl ether acetate, tripropylene glycol methyl ether, tripropylene glycol ethyl ether, tripropylene glycol propyl ether, tripropylene glycol n-butyl ether, tripropylene glycol t-butyl ether) and mixtures thereof (preferably, isopropanol, ethanol, 2-(2-butoxyethoxy)ethanol, ethylene glycol butyl ether, propylene glycol methyl ether, propylene glycol propyl ether, propylene glycol t-butyl ether, dipropylene glycol methyl ether, dipropylene glycol propyl ether, dipropylene glycol n-butyl ether and mixtures thereof; more preferably, dipropylene glycol methyl ether).

Preferably, the aqueous hard surface cleaning composition of the present invention has a pH of 3.5 to 9.0 (preferably, 4.0 to 8.0; more preferably, 5 to 8; most preferably, 6 to 8).

Preferably, the aqueous hard surface cleaning formulation of the present invention contains less than 0.003 wt % (preferably, <0.001 wt %; more preferably, <0.0001 wt %; most preferably, less than detectable limit), based on weight of the aqueous hard surface cleaning formulation, of a quaternary ammonium salt having at least one C₈₋₁₈ alkyl group.

Preferably, the aqueous hard surface cleaning formulation of the present invention contains less than 0.05 wt % (preferably, <0.01 wt %; more preferably, <0.001 wt %; still more preferably, <0.0001 wt %; most preferably, <detectable limit), based on weight of the aqueous hard surface cleaning formulation, of a cationic biocide; wherein the cationic biocide is selected from the group consisting of quaternary ammonium salts (“quats”) and biguanide compounds. More preferably, the aqueous hard surface cleaning formulation of the present invention contains less than 0.05 wt % (preferably, <0.01 wt %; more preferably, <0.001 wt %; still more preferably, <0.0001 wt %; most preferably, <detectable limit), based on weight of the aqueous hard surface cleaning formulation, of a cationic biocide; wherein the cationic biocide is selected from the group consisting of quaternary ammonium salts (“quats”) and biguanide compounds; wherein the biguanide compounds having formula (III)

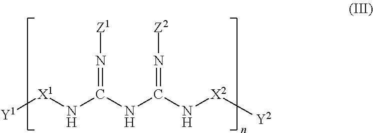

wherein X¹ and X² are independently selected from the group consisting of a hydrogen, an aliphatic group, a cycloaliphatic group, an aromatic group, a substituted aliphatic group, a substituted aromatic group, a heteroaliphatic group, a heterocyclic group and a heteroaromatic group; wherein Y¹ and Y² are independently selected from the group consisting of an aliphatic group, a cycloaliphatic group, an aromatic group, a substituted aliphatic group, a substituted aromatic group, a heteroaliphatic group, a heterocyclic group and a heteroaromatic group; wherein n has an average value of 2 to 20; wherein Z¹ and Z² are independently selected from a hydrogen and a salt anion (e.g., halide, nitrate, sulfate); and wherein the weight average molecular weight of the biguanide compound is 500 to 2,000 Daltons.

Preferably, the aqueous hard surface cleaning formulation of the present invention contains less than 0.01 wt % (preferably, <0.001 wt %; more preferably, <0.0001 wt %; most preferably, <detectable limit), based on weight of the aqueous hard surface cleaning formulation, of a castor oil derivative; wherein the castor oil derivative has a formula selected from formula IV and formula V

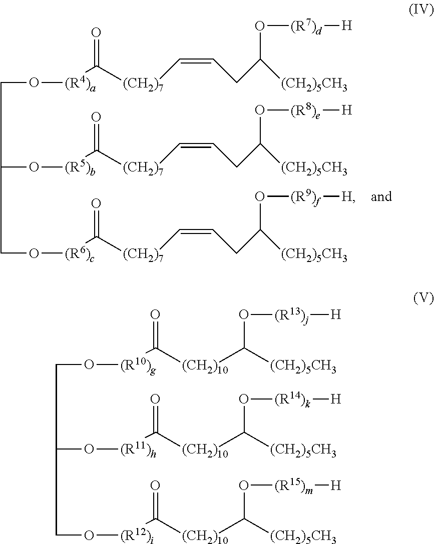

wherein R⁴, R⁵, R⁶, R⁷, R⁸, R⁹, R¹⁰, R¹, R¹², R¹³, R¹⁴ and R¹ are each independently selected from the group consisting of a —CH₂CH₂O— group, a —CH₂CH₂CH₂O— group, a —CH₂CH₂CH₂CH₂O— group, a —CH(CH₃)CH₂O— group, a —CH₂CH(CH₃)O— group, a —CH(CH₃)CH₂CH₂O— group, a —CH₂CH(CH₃)CH₂O— group and a —CH₂CH₂CH(CH₃)O— group each a —CH₂CH₂O— group; wherein a, b, c, d, e, f, g, h, l, j, k and m are each independently a number of 0 to 250; wherein the average sum of a+b+c+d+e+f is 1 to 250; wherein the average sum of g+h+i+j+k+m is 1 to 250.

Preferably, the aqueous hard surface cleaning formulation of the present invention contains less than 0.5 wt % or greater than 3 wt % (preferably, <0.1 wt % or greater than 5 wt %; more preferably, <0.01 wt %; still more preferably, <0.001 wt %; most preferably, less than detectable limit), based on weight of the aqueous hard surface cleaning formulation, of a mixture of (a) amino carboxylic acid chelator and (b) polycarboxylic acid chelator; wherein the amino carboxylic acid chelator is a chelating agent having a nitrogen atom and a carboxy group; and wherein the polycarboxylic acid chelator is a chelating agent having at least two functional groups per molecule including at least one carboxy group, wherein the functional groups are selected from carboxy groups and a hydroxy groups (e.g., acetic acid, adipic acid, monochloroacetic acid, oxalic acid, succinic acid, oxydisuccinic acid, carboxymethylsuccinic acid, carboxy methyloxy succinic acid, glycolic acid, diglycolic acid, lactic acid, tartaric acid, carboxymethyltartaric acid, citric acid, malic acid, gluconic acid and salts thereof).

Preferably, the aqueous hard surface cleaning formulation of the present invention contains less than 0.5 wt % (preferably, <0.1 wt %; more preferably, <0.01 wt %; still more preferably, <0.001 wt %; most preferably, less than detectable limit), based on weight of the aqueous hard surface cleaning formulation, of an ingredient of formula (VI)

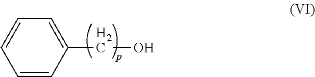

wherein p is 1 or 2 (alternatively, wherein p is 1 to 8).

Preferably, the aqueous hard surface cleaning formulation of the present invention contains less than 0.01 wt % (preferably, <0.001 wt %; more preferably, <0.0001 wt %; most preferably, <detectable limit), based on weight of the aqueous hard surface cleaning formulation, of zwitterionic surfactant.

Preferably, the aqueous hard surface cleaning formulation of the present invention contains less than <0.01 wt % (preferably, <0.001 wt %; more preferably, <0.0001 wt %; most preferably, <detectable limit), based on weight of the aqueous hard surface cleaning formulation, of anionic surfactant.

Preferably, the method of cleaning a hard surface of the present invention, comprises selecting an aqueous hard surface cleaning formulation of the present invention, applying the aqueous hard surface cleaning formulation to a soiled hard surface having a material to be removed (e.g., at least one of dirt, grease, oil); and rubbing the aqueous hard surface cleaning formulation on the soiled hard surface (preferably, wherein the aqueous hard surface cleaning formulation is used in conjunction with an implement) to provide a cleaned hard surface, wherein at least some of the material to be removed has been removed. Preferably, the cleaned hard surface may further be rinsed with water. Preferably, the cleaned hard surface may further be rinsed with water and then dried.

Preferably, the aqueous hard surface cleaning formulation of the present invention is used in conjunction with an implement to clean hard surfaces. The implement may be primarily manual in nature (e.g., a hand held scrub brush) or may be at least partially powered (e.g., a motorized scrubbing device).

Preferably, the aqueous hard surface cleaning formulation is applied to the soiled hard surface by at least one of spraying, pouring and preloading onto an implement used in conjunction with the hard surface cleaning formulation.

Preferably, the aqueous hard surface cleaning formulation of the present invention is used in conjunction with an implement; wherein the implement is selected from the group consisting of at least one of a brush, a mop, a sponge, and a woven or nonwoven cloth or towel. Preferably, the implement includes an absorbent/adsorbent material, for example, a woven material (e.g., woven cotton fibers, woven cotton/nylon blend fibers); a nonwoven material (e.g., nonwoven fibrous sheet materials, such as, meltblown materials, spun bond materials, coform materials, wet laid materials, air laid materials, bonded-carded materials, web materials and hydroentangled materials); a sponge/sponge like material (e.g., natural sponge, regenerated cellulose, polyurethane foam). Preferably, the implement includes an absorbent/adsorbent material, wherein the aqueous hard surface cleaning formulation is preloaded on the absorbent/adsorbent material before contacting the aqueous hard surface cleaning formulation with the soiled hard surface.

Fibers in nonwoven materials used in conjunction with the aqueous hard surface cleaning formulation of the present invention may include, for example, polyester fibers, rayon fibers, nylon fibers, polypropylene fibers, polyethylene fibers, cellulose fibers and mixtures thereof.

Some embodiments of the present invention will now be described in detail in the following Examples.

### Comparative Examples C1-C12 and Examples 1-2: Formulations

Aqueous hard surface cleaning formulations were prepared according to Comparative Examples C1-C12 and Examples 1-2 by adding the surfactant, as noted in TABLE 2, to water and shaking until dissolved; and then adding the solvent, as noted in TABLE 2, if any, and rolling on a benchtop roller until dissolved.

### Formulation Phase Stability

The Phase Stability of the aqueous hard surface cleaning formulations prepared according to Comparative Examples C1-C12 and Examples 1-2 was assessed by storing the formulations at 21° C. for a period of 20 days and observing for the extent of phase separation, if any, present in the stored formulations. The results of the assessment are provided in TABLE 2.

### Turbidity

The turbidity of the aqueous hard surface cleaning formulations prepared according to Comparative Examples C1-C12 and Examples 1-2 was measured after storing the formulations at 21° C. for a period of at least 20 days using a turbidity meter at 21° C. The meter was calibrated according to instructions included with the machine. The measured turbidities in Nephelometric Turbidity Units (NTU) are provided in TABLE 2.

TABLE 2

| | Surfactant | | Solvent | | | |
|---|---|---|---|---|---|---|
| | | Conc. | | Conc. | | Turbidity |
| Example | Type | (wt %) | Type | (wt %) | Stable | (NTU) |
| C1 | A | 1 | None | — | No | 44 |
| C2 | A | 1 | B | 4 | No | 53 |
| C3 | A | 1 | C | 4 | No | 25 |
| C4 | A | 1 | D | 4 | No | 110 |
| C5 | A | 1 | E | 4 | No | 64 |
| C6 | A | 1 | F | 4 | No | 166 |
| C7 | A | 1 | G | 4 | No | 48 |
| C8 | A | 1 | H | 4 | No | 45 |
| C9 | A | 1 | I | 4 | No | 45 |
| C10 | A | 1 | J | 4 | No | 185 |
| C11 | A | 1 | K | 4 | No | 180 |
| C12 | A | 1 | L | 4 | No | 17 |
| 1 | A | 1 | M | 4 | Yes | 8 |
| 2 | A | 1 | N | 4 | Yes | 8 |

A ECOSURF ™ EH-3 alcohol ethoxylate from The Dow Chemical Company
B CARBITOL ™ Diethylene glycol monoethyl ether from The Dow Chemical Company
C Butyl CARBITOL ™ Diethylene glycol monobutyl ether from The Dow Chemical Company
D Hexyl CARBITOL ™ Diethylene glycol monohexyl ether from The Dow Chemical Company
E Butyl CELLOSOLVE ™ Ethylene glycol monobutyl ether from The Dow Chemical Company
F Hexyl CELLOSOLVE ™ Ethylene glycol monohyexyl ether from The Dow Chemical Company
G DOWANOL ™ PM Propylene glycol methyl ether from The Dow Chemical Company
H DOWANOL ™ TPM Tripropylene glycol methyl ether from The Dow Chemical Company
I DOWANOL ™ DPM Dipropylene glycol methyl ether from The Dow Chemical Company
J DOWANOL ™ EPh Ethylene glycol phenyl ether from The Dow Chemical Company
K Diethylene glycol monophenyl ether (average component)
L Pentadecylethylene glycol monophenyl ether (average component)
M Tetraethylene glycol monophenyl ether (average component)
N DOWANOL ™ EPh6 Hexaethylene glycol monophenyl ether (average component) from The Dow Chemical Company

### Comparative Examples C13-C37 and Examples 3-5: Formulations

Aqueous hard surface cleaning formulations were prepared according to Comparative Examples C13-C37 and Examples 3-5 by adding the surfactant, as noted in TABLE 3, to water and shaking until dissolved; and then adding the solvent, as noted in TABLE 3, if any, and rolling on a benchtop roller until dissolved.

### Formulation Phase Stability

The Phase Stability of the aqueous hard surface cleaning formulations prepared according to Comparative Examples C13-C37 and Examples 3-5 was assessed by storing the formulations at 21° C. for a period of 20 days and observing for the extent of phase separation, if any, present in the stored formulations. The results of the assessment are provided in TABLE 3.

### Cloud Point Temperature

The cloud point temperature for the aqueous hard surface cleaning formulations prepared according to Comparative Examples C13-C37 and Examples 3-5 was determined by placing a 1 mL sample of the aqueous hard surface cleaning formulation to a 1.5 mL clear glass vial and measuring transmission of light (at 645 nm) through the formulation as a function of temperature using a Technobis Crystallization Systems Crystal16. The cloud point temperature was recorded as the temperature at which the transmission of light (at 645 nm) through the sample dropped below 100%. The results are provided in TABLE 3.

### Cleaning Performance

The cleaning performance of the aqueous hard surface cleaning formulations prepared according to Comparative Examples C13-C37 and Examples 3-5 was determined using the following procedure. A tile (Premium Excelon Feature Tile & Strip, Chalk II 56830/L597A available from ArmstrongFlooring) was soiled with 500 μL of a naptha and carbon black based dirt. The dirt was prepared by mixing 61.04 wt % Naptha 60/110, 27.6 wt % Vognis Myritol 318, 8.2 wt % soybean oil and 3.18 wt % Mogyul L carbon black using a stirbar in a beaker until all the carbon black was suspended. The dirt was then applied to the center of the tile and painted using a sponge applicator through 20 up and down movements while holding the tile at a 45 to 90° angle relative to the ground. The tile was then left to dry in overnight. The tile was then placed in a device for retaining a nonporous substrate as described in U.S. Patent Application Publication No. 20100083778, the disclosure of which is incorporated herein by reference is its entirety, wherein the removable well insert had 24 openings. The individual openings were filled with 400 μL of aqueous hard surface cleaning formulation and capped with 3 mm needle punch carpet purchased from The Felt Store Inc. (West Seneca, NY) adhered to 12.7 g conic weight. The plate and tile were mechanically moved laterally back and forth relative to one another to scrub the surface of the tile for 5 minutes. The plate was then removed and the surface of the tile was rinsed with deionized water. The surface of the scrubbed tile was then analyzed using a EPSON Perfection V500 Photo Scanner and ImageJ software to extract the gray value of each well on the scrubbed tile for each formulation. The gray value for each scrubbed tile region was then compared with the gray values measured for the original tile before soiling and the soiled region of the tile before cleaning. Note that a value of 0% corresponds with a gray value equal to that of the soiled region before cleaning and a value of 100% would correspond with a gray value equal to that of the original tile before soiling. The results are provided in TABLE 3.

TABLE 3

| | Surfactant | | Solvent | | | Cloud | |
|---|---|---|---|---|---|---|---|
| | | Conc. | | Conc. | | Point | Cleaning |
| Ex. | Type | (wt %) | Type | (wt %) | Stable | (° C.) | (%) |
| C13 | NA | 0 | J | 2 | Yes | NA | 29 |
| C14 | NA | 0 | J | 4 | Yes | NA | 29 |
| C15 | A | 2 | NA | 0 | Yes | 37 | 28 |
| C16 | A | 2 | J | 4 | Yes | 75 | 17 |
| C17 | A | 2 | J | 10 | Yes | 83 | 13 |
| C18 | B | 2 | NA | 0 | No | <20 | NA |
| C19 | B | 2 | J | 10 | Yes | 76 | 13 |
| C20 | C | 2 | NA | 0 | No | <20 | NA |
| C21 | D | 2 | NA | 0 | No | <20 | NA |
| C22 | D | 2 | J | 4 | No | <20 | NA |
| C23 | D | 2 | J | 10 | Yes | 74 | 29 |
| C24 | E | 2 | NA | 0 | Yes | 45 | 0 |
| C25 | E | 2 | J | 4 | Yes | 83 | 12 |
| C26 | E | 2 | J | 10 | Yes | 86 | 6 |
| C27 | F | 2 | NA | 0 | Yes | 32 | 4 |
| C28 | F | 2 | J | 4 | Yes | 62 | 3 |
| C29 | F | 2 | J | 10 | Yes | 76 | 7 |
| C30 | G | 2 | NA | 0 | Yes | >100 | 4 |
| C31 | G | 2 | J | 4 | Yes | >100 | 2 |
| C32 | G | 2 | J | 10 | Yes | >100 | 6 |
| C33 | H | 2 | NA | 0 | Yes | 38 | 14 |
| C34 | H | 2 | J | 4 | Yes | 48 | 4 |
| C35 | H | 2 | J | 10 | Yes | 63 | 0 |
| C36 | I | 2 | NA | 0 | Yes | 40 | 81 |
| C37 | I | 2 | J | 4 | Yes | 66 | 22 |
| 3 | C | 2 | J | 4 | Yes | 30 | 75 |
| 4 | B | 2 | J | 4 | Yes | 39 | 77 |
| 5 | C | 2 | J | 4 | Yes | 30 | 75 |

A TERGITOL ™ 15-S-7 Nonionic secondary alcohol ethoxylate from The Dow Chemical Company with a reported HLB of 12.1
B TERGITOL ™ 15-S-5 Nonionic secondary alcohol ethoxylate from The Dow Chemical Company with a reported HLB of 10.5
C ECOSURF ™ EH-3 Nonionic alcohol ethoxylate from The Dow Chemical Company with a reported HLB of 7.9
D BIOSOFT ™ N25-3 Linear alcohol ethoxylate from Stepan with a reported HLB of 8.0
E BIOSOFT ™ N25-7 Linear alcohol ethoxylate from Stepan with a reported HLB of 12.2
F TERGITOL ™ L-62 Nonionic polyether polyol from The Dow Chemical Company with a reported HLB of 7.0
G TRITON ™ CG-50 Nonionic alkyl polyglucoside from The Dow Chemical Company
H ECOSURF ™ LFE-635 Nonionic branched alcohol alkoxylate from The Dow Chemical Company with a reported HLB of 9.5-10.5
I ECOSURF ™ EH-6 Nonionic alcohol ethoxylate from The Dow Chemical Company
J DOWANOL ™ EPh6 Hexaethylene glycol monophenyl ether (average component) from The Dow Chemical Company

We claim:

1. An aqueous hard surface cleaning formulation, comprising:
(a) water
(b) 0.1 to <5 wt %, based on weight of the aqueous hard surface cleaning formulation, of a nonionic branched alcohol alkoxylate surfactant having a hydrophobic-lipophilic balance, HLB, of 0.5 to 11.5; and
(c) 0.01 wt % to 25 wt %, based on weight of the aqueous hard surface cleaning formulation, of an ethoxylated phenol having formula (T) 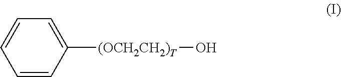
wherein T is an average of >2.5 to 14;
wherein the aqueous hard surface cleaning formulation has a weight ratio (c)/(b) equal to the weight of the ethoxylated phenol (c) contained in the aqueous hard surface cleaning formulation divided by the weight of the nonionic surfactant (b) contained in the aqueous hard surface cleaning formulation of 0.1 to <5;
wherein the aqueous hard surface cleaning formulation contains less than 0.003 wt %, based on weight of the aqueous hard surface cleaning formulation, of a quaternary ammonium salt having at least one C₈₋₁₈ alkyl group;
wherein the aqueous hard surface cleaning formulation contains less than 0.05 wt %, based on weight of the aqueous hard surface cleaning formulation, of cationic biocide; wherein cationic biocide is selected from the group consisting of quaternary ammonium salts and biguanide compounds;
wherein the aqueous hard surface cleaning formulation contains <0.01 wt %, based on weight of the aqueous hard surface cleaning formulation, of castor oil derivative;
wherein the aqueous hard surface cleaning formulation contains <0.5 wt % or >3 wt %, based on weight of the aqueous hard surface cleaning formulation, of a mixture of (a) amino carboxylic acid chelator and (b) polycarboxylic acid chelator; wherein the amino carboxylic acid chelator is a chelating agent having a nitrogen atom and a carboxy group; and wherein the polycarboxylic acid chelator is a chelating agent having at least two functional groups per molecule including at least one carboxy group, wherein the functional groups are selected from carboxy groups and a hydroxy groups;
wherein the aqueous hard surface cleaning formulation contains less than 0.5 wt %, based on weight of the aqueous hard surface cleaning formulation, of an ingredient of formula (VI) 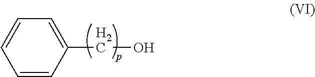
wherein p is 1 or 2.

2. The aqueous hard surface cleaning formulation of claim 1, wherein the aqueous hard surface cleaning formulation is phase stable after being stored for 20 days at 21° C.

3. The aqueous hard surface cleaning formulation of claim 2, wherein the aqueous hard surface cleaning formulation has a cloud point temperature of 25 to <40° C.

4. The aqueous hard surface cleaning formulation of claim 3, wherein T is an average of 3.25 to 8.

5. The aqueous hard surface cleaning formulation of claim 3, wherein T is an average of 3.5 to 7.

6. The aqueous hard surface cleaning formulation of claim 3, wherein T is an average of 3.75 to 6.5.

7. The aqueous hard surface cleaning formulation of claim 4, further comprising an additive selected from the group consisting of a salt, a builder, an enzyme (e.g., protease, amylase, lipase, cellulase), a corrosion inhibitor, a pH adjusting agent (e.g., an acid), a bleaching agent (e.g., sodium percarbonate, sodium perborate), a bleach activator (e.g., tetraacetylethylenediamine (TAED)), a bleach catalyst (e.g., manganese(II) acetate, cobalt(II) chloride, bis(TACN)magnesium trioxide diacetate), an abrasive, a fragrance, an antimicrobial agent (e.g., biocides), a colorant (e.g., dyes); a thickener; foam stabilizer; foam enhancer; chelating agent; a hydrotrope; an organic cosolvent and mixtures thereof.

8. The aqueous hard surface cleaning formulation of claim 7, wherein the aqueous hard surface cleaning formulation contains <0.01 wt %, based on weight of the aqueous hard surface cleaning formulation, of zwitterionic surfactant.

9. The aqueous hard surface cleaning formulation of claim 8, wherein the aqueous hard surface cleaning formulation contains <0.01 wt %, based on weight of the aqueous hard surface cleaning formulation, of anionic surfactant.

10. A method of cleaning a hard surface, comprising:
selecting an aqueous hard surface cleaning formulation according to claim 1;
applying the aqueous hard surface cleaning formulation to a soiled hard surface having a material to be removed; and
rubbing the aqueous hard surface cleaning formulation on the soiled hard surface to provide a cleaned hard surface, wherein at least some of the material to be removed has been removed.
